(19) United States
(12) Patent Application Publication
(10) Pub. No.: US 2009/0225424 A1
(43) Pub. Date: Sep. 10, 2009

(54) MICRO-OPTICAL DIFFRACTION GRID AND PROCESS FOR PRODUCING THE SAME

(76) Inventors: Fabian Zimmer, Dresden (DE); Harald Schenk, Dresden (DE)

Correspondence Address: BARNES & THORNBURG LLP, 11 SOUTH MERIDIAN, INDIANAPOLIS, IN, 46204, US

(21) Appl. No.: 12/088,010

(22) PCT Filed: Sep. 30, 2005
(86) PCT No.: PCT/DE05/01799

§ 371 Date: Jun. 3, 2008

(51) Int. Cl. G02B 5/18; B05D 5/06; B29D 11/00

(52) U.S. Cl. 359/572; 427/162; 427/532; 427/543; 216/24

(57) ABSTRACT

The invention relates to microoptical diffraction gratings for electromagnetic radiation and to a method suitable for the manufacture thereof. The diffraction gratings in accordance with the invention can in particular be utilized for use as microspectrometers which can be used in this connection in the form of scanning microgratings. In accordance with the object set, they should be provided with improved surface topology and should be able to be manufactured cost effectively and in high volumes. With the diffraction gratings in accordance with the invention, a surface structure is formed at a surface of a substrate and is formed from linear structural elements arranged equidistantly and aligned parallel to one another. In addition, the total surface of the substrate and of the structural elements is coated with at least one further layer which forms a uniform sinusoidal surface contoured in wave shape and having alternatingly arranged wave peaks and wave troughs. With reflection gratings, a reflective layer can additionally be applied to increase the intensity of reflected radiation.

The invention relates to microoptical diffraction gratings for electromagnetic radiation and to a method suitable for the manufacture thereof. The diffraction gratings in accordance with the invention can in particular be utilized for use as microspectrometers which can be used in this connection in the form of scanning microgratings.

Such microspectrometers with pivotable diffraction gratings have been described, for example, by H. Grüger et al. in “Performance and Applications of a spectrometer with micromachined scanning grating”; Micromachining and Microfabrication, part of SPIE Photonic West (2003).

Very small micromechanical systems are desired for a number of applications; accordingly, the diffraction gratings used therein must be provided in correspondingly small form. As already indicated, in this process, the diffraction gratings are pivoted around an axis of rotation and the electromagnetic radiation which is directed onto such a diffraction grating from a corresponding radiation source is guided sequentially in a spectral range via one or more detectors suitable for the detection of specific wavelengths of the electromagnetic radiation.

Usually, highly precise and efficient diffraction gratings are manufactured by a casting process from a so-called master or also by holographic processes. For the forming from a master, the latter must be manufactured in advance. In this connection, the manufacture takes place such that equidistant lines are formed in a substrate, which consists e.g. of metal, by means of a scoring tool. The forming from such a master can then e.g. take place by means of a hardening plastic, e.g. from epoxy resin. Subsequent to the forming, a metallic layer of high reflectance can be applied to such a formed structure.

It is, however, problematic in this connection that a considerable mechanical pressure is required for the forming and that considerable compressive forces act on the substrates which typically have a thickness of only some few 10 μm. Problems moreover occur with the required lateral adjustment precision.

In addition, the possible number of pieces of individual diffraction grating elements of such a forming from a master is limited. The production costs of such diffraction gratings suitable for micromechanical applications are naturally thereby increased.

Holographic processes for the manufacture of corresponding diffraction gratings are based on the interference principle with a use of laser radiation. An intensity profile arises by interference of partial laser rays which is sinusoidal to some extent and with which the photosensitive layer on a substrate is illuminated with the corresponding interference pattern. This interference intensity profile is then transferred onto the photosensitive layer in topological form after the exposure and subsequent development. The photosensitive layer can subsequently be coated with a highly reflective metal film.

However, the installation technology such as is usually used in a mature form in semiconductor manufacture cannot be used in the manufacture so that an additional implementation in such an installation technology is required.

It is moreover known to manufacture diffraction gratings with a corresponding surface topology by the process techniques known per se of gray-scale lithography. In this connection, however, the number/spacing of the individual lines of a diffraction grating is limited so that the spectral resolution of such a diffraction grating is likewise limited.

Diffraction gratings can, however, also be provided by a simple structuring of a reflective layer applied to a substrate. In this connection, a rectangular diffraction grating can be obtained in a first approximation. The diffraction gratings manufactured in this way, however, have a low effectiveness and can accordingly only be used for spectral analysis with high-intensity sources for electromagnetic radiation.

It is therefore the object of the invention to provide efficient microoptical diffraction gratings with a suitable surface structure which can be manufactured in a cost-effective manner and in high volumes.

In accordance with the invention, this object is solved by a microoptical diffraction grating having the features of claim 1. They can be manufactured using a method in accordance with claim 13.

Advantageous embodiments and further developments of the invention can be achieved using the features designated in the subordinate claims.

The diffraction gratings for electromagnetic radiation in accordance with the invention are made such that a surface structure is formed at a surface of a substrate.

This surface structure consists of linear structural elements which are arranged equidistant from one another and which should moreover be aligned parallel to one another. The linear structural elements accordingly form elevated portions at the respective surface of the substrate. This can be achieved by forming likewise linear recesses in the surface.

At least one layer is then formed over the whole surface of the substrate, that is, also over the surfaces of the structural elements, said layer forming a uniform sinusoidal surface contoured in wave shape and having alternatingly arranged wave peaks and wave troughs. Such a wave-shaped surface contour can be formed independently of the linear surface structure in the formation of the at least one layer since a rounding effect can be utilized in the coating technologies which can be used for the manufacture of diffraction gratings in accordance with the invention.

The cross-sectional geometry in which the structural elements are formed on the respective surface of a substrate is thus insignificant to a limited degree. Structural elements can thus have triangular, rectangular or also trapezoidal cross-sectional shapes having corresponding edge regions and nevertheless an almost continuous wave-shaped surface structure can be formed.

At least partly elliptical cross-sectional shapes of structural elements, which can be formed, for example, by lateral etching, which will be looked at later in the following, can also be easily controlled in the formation of the wave-shaped surface contour.

Advantageously, the at least one or more individual layers formed over one another form a sinusoidal surface. This can in particular be achieved in that at least one layer is made from a material or from a material mix which is plastically deformable by an energy input. The energy input should preferably be carried out after the formation of the layer(s). In this connection, the viscosity can be reduced to the extent the material/material mix flows and deforms in so doing. The deformation is maintained after the end of the energy input. A much more regularized surface topology can thereby be achieved which is made at least almost sinusoidal and very uniform wave peaks and wave troughs with convex or concave curvatures can be formed.

Suitable materials or material mixes are, for example, borophosphosilicate glass (BPSG), metals, e.g. Al, Ni, Au, Ag, Cr, Cu or also metal alloys such as AlSiCu, AlCu or polymers such as BCB, PMMA, SU-8 or photoresists (e.g. AZ7212, AZ 7217).

The input of energy can take place in different forms. A radiation with electromagnetic waves which are preferably absorbed by the respective material or material mix can thus be used.

A thermal treatment can, however, also be carried out in a different fashion by annealing in a furnace.

There is, however, also the possibility of introducing the energy input by means of electrical resistance heating or induction, whereby then electrically conductive parts can be connected to an electrical voltage source in suitable form or a coated substrate can be exposed to an electrical or electromagnetic alternating field.

The plastic deformability can, however, also be achieved by chemical activation of a material or material mix as a result of the introduced energy.

The surface of the substrate on which the structural elements are arranged can in particular be smooth and planar on the use of diffraction gratings in accordance with the invention for use in a predetermined spectral range of electromagnetic radiation.

There is moreover the possibility to provide the diffraction gratings in accordance with the invention as transmission gratings or also as reflection gratings.

With a transmission grating, at least one layer, e.g. made from the respective substrate material, should then be applied to a substrate transparent for the respective radiation range and the wave-shaped surface contour should be formed with this at least one layer.

In the case of reflection gratings, such a layer can be formed from a material which reflects the respective electromagnetic radiation, with there also being the possibility of forming a plurality of such reflective layers over one another. Highly reflective metals or metal alloys can thus be used for such layers, for example. Aluminum, silver, gold or a corresponding alloy should be named by way of example here.

In the event that a plurality of layers should be formed over the total surface of a diffraction grating in accordance with the invention, said layers do not necessarily have to be formed from correspondingly reflective materials. There is thus the possibility of forming corresponding reflective multilayer systems of alternatingly arranged layers of a respective material with a higher optical refractive index and of a material with a lower optical refractive index. Such a multilayer system is then likewise able to form a reflection grating.

In this connection, however, interference can also be used and the respective layer thicknesses of such layers of multilayer systems for presettable wavelengths can each be formed as so-called λ/4 layers, with the respective layer thicknesses then taking up a whole number multiple of λ/4 of a correspondingly predetermined wavelength. In this connection, the respective angle of incidence of the corresponding electromagnetic radiation onto the radiated surface of the diffraction grating is naturally a parameter to be taken into account.

With the microoptical diffraction gratings in accordance with the invention, a matching to selected wavelength spectra such as extreme ultraviolet (EUV), deep ultraviolet (DUV), ultraviolet, visible light, near infrared (NIR) and infrared is possible.

The diffraction gratings in accordance with the invention can be manufactured such that a layer, for example a photoresist layer, is formed on a surface of a substrate and the photoresist is structured by a photolithographic process with subsequent developing so that in a following etching step, e.g. by known dry physical methods or dry chemical methods or wet chemical methods, linear recesses can be formed in the substrate and thereby the structural elements at the substrate. In this connection, use can be made of conventional installation technology such as is usually used in the semiconductor industry.

A structuring can thus be obtained with current technology with linear structural elements of more than 5000 on 1 mm.

A specific preselected surface topology with a suitable cross-sectional profile can be formed in a reproducible manner.

A substrate pretreated in this manner can then, as already addressed in general form, be coated with at least one layer which then forms the wave-shaped surface contour. PVD or CVD processes known per se can be used for the forming of the layer.

There is thus easily the possibility of simultaneously processing a correspondingly large-format diffraction grating or a plurality of small-format diffraction gratings on a substrate in one respective technological step, whereby the single piece costs can be considerably reduced over conventional solutions.

Furthermore, atoms of foreign elements can be implanted into at least one layer. This results in adapted or optimized flow properties, strains, stress or adapted thermal coefficients of expansion.

It can moreover be advantageous additionally to form at least one layer on a side of the substrate. The residual stress relationships can thereby be influenced. There is the possibility of thereby compensating residual stresses present in advance.

A direct deformation of the diffraction grating can, however, also be achieved by one or more layer(s) formed at the substrate at least one side. For example, an arching of the structured surface can thus be compensated and a smooth planar surface can be achieved, with the exception of the surface topology.

However, a concave or convex arching/curvature of the structured surface can also be achieved by layers having layers formed at a side and acting on the substrate to influence the optical properties, e.g. the focal length.

In this connection, the stress relationships and, where necessary, the arching/curvature can be selected for a diffraction grating in accordance with the invention formed in this manner while taking account of the respective operating temperature range.

This can be influenced, for example, by a suitable selection of the layer materials with corresponding thermal coefficients of expansion, of the number and/or of the thickness of layers for at least one side of substrates.

The invention will be explained in more detail by way of example in the following.

There are shown:

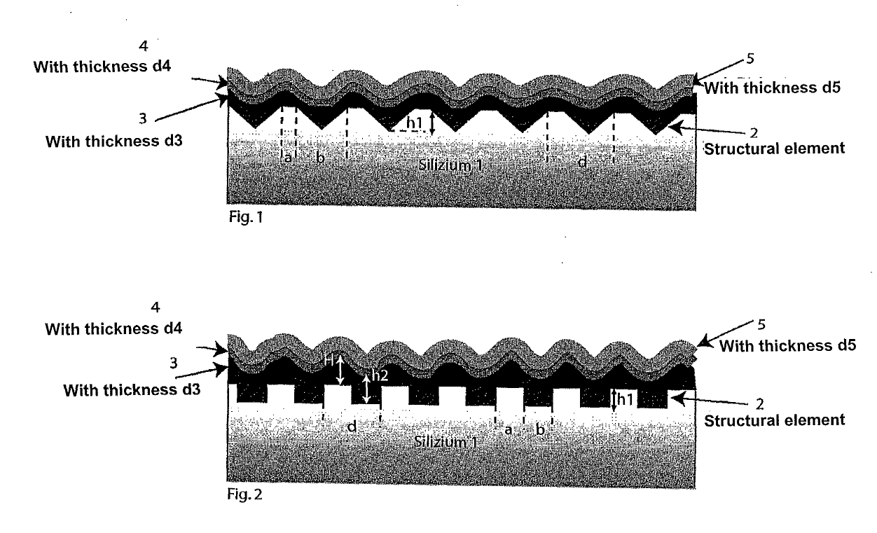

FIG. 1 a partial section of an example for a diffraction grating in accordance with the invention, as a reflection grating, in a schematic representation; and

FIG. 2 a partial section of a further example in a schematic representation.

In the form shown in FIGS. 1 and 2, there is the possibility of forming recesses photolithographically in a substrate 1 made of silicon, said recesses being linear after an etching step and forming structural elements 2 at the surface of the substrate 1. The linear structural elements 2, which are aligned parallel with one another, have a trapezoidal (FIG. 1) or rectangular (FIG. 2) cross-section. The structural elements 2 have a height h1 and a structural element width d. The structures described repeat periodically.

Subsequently, a highly reflective layer 3 of aluminum can be formed, by magnetron sputtering for example, over the total surface of the substrate 1, that is also above the structure elements 2. The deposited layer 3 forms a surface contour in wave shape so that between the structural elements 2 in troughs it had a layer thickness h2 in the middle between two adjacent structural elements 2 and above structural elements 2 a height H. A sinusoidal surface structure was able to be achieved after formation of the layer 3.

In the example shown in FIG. 1, linear structural elements 2 having a triangular cross-section were formed by wet chemical etching or anisotropic etching on the surface of a substrate 1 which was formed from (100)-silicon. On a variation of the parameters or of the substrate orientation, however, other cross-sectional elements for structural elements 2, for example rectangular cross-sections, as in the example of FIG. 2, can also be formed.

A layer 3 of borophosphosilicate glass (BSG) was deposited on a substrate 1 prepared in this way and the surface contour formed using the structural elements 2 was mapped or rounded with larger layer thicknesses. Subsequently, the coated substrate 1 was annealed and a further plastic deformation of the layer 3 was achieved by the heating, which resulted in a sinusoidal surface contour on the surface of the layer 3 with alternatingly arranged wave peaks and wave troughs which are arranged between the structural elements 2.

At least one further layer 4, for example of silicon nitride, can be applied to the layer 3 to achieve a further compensation of residual strains.

A reflective layer 5 can be applied directly to the layer 3 or, as shown in FIGS. 1 and 2, also applied to a layer 4. The layer 5 has been deposited from aluminum here.

The thicknesses d3, d4 and d5 of the layers 3, 4 and 5, the geometry, the dimensioning a, b and h1 as well as the spacings of the structural elements 2 have been selected in this context so that a sinusoidal surface topology and freedom from residual strain were able to be reached at the surface of the diffraction grating.

1. A microscopic diffraction grating for electromagnetic radiation,
wherein a surface structure is formed at a surface of a substrate and is formed from linear structural elements arranged equidistantly and aligned parallel to one another; and
the total surface of the substrate and of the structural elements is coated with at least one further layer, with
the at least one further layer forming a uniform surface contoured sinusoidally in wave shape and having alternately arranged wave peaks and wave troughs.

2. A diffraction grating in accordance with claim 1 wherein at least one of the layers is made from at least one of a material and a material mix which is plastically deformable under the effect of energy.

3. A diffraction grating in accordance with claim 1 wherein the surface of the substrate at which the structural elements are formed is made as a smooth planar surface.

4. A diffraction grating in accordance with claim 1 wherein the at least one further layer reflects electromagnetic radiation.

5. A diffraction grating in accordance with claim 4 wherein the at least one layer is formed from at least one of a highly reflecting metal and a metal alloy.

6. A diffraction grating in accordance with claim 5 wherein the layer is made from at least one of aluminum, silver, gold and alloys thereof.

7. A diffraction grating in accordance with claim 1 wherein a plurality of layers form a multilayer system formed form alternately arranged layers of materials having higher and lower optical refractive indices.

8. A diffraction grating in accordance with claim 1 wherein the at least one layer has a layer thickness corresponding to a whole number multiple of λ/4, λ being a predetermined wavelength.

9. A diffraction grating in accordance with claim 1 wherein the structural elements have one of a triangular cross-section, a rectangular cross-section, a trapezoidal cross-section and a cross-section made at least partly in the form of an ellipse.

10. A diffraction grating in accordance with claim 1 wherein atoms of other elements are implanted in at least one of the layers.

11. A diffraction grating in accordance with claim 1 wherein at least one layer is arranged on the rear side of the substrate.

12. A diffraction grating in accordance with claim 11 wherein the substrate with the at least one layer formed on it is curved.

13. A method for the manufacture of a diffraction grating in accordance with claim 1 wherein the surface of a substrate with linear structural elements arranged equidistantly thereon is coated at least regionally with at least one further layer and a uniform surface contoured sinusoidally in wave shape is obtained.

14. A method in accordance with claim 13 wherein linear recesses are formed in a surface of the substrate and the structural elements are thus formed at the surface.

15. A method in accordance with claim 13 wherein the arching of the surface is regularized and adapted to the sinusoidal shape by applying energy to the at least one further layer and by the resulting plastic deformation of the at least one of a material and a material mix from which the at least one layer is formed.

16. A method in accordance with claim 15 wherein a subsequent heating is carried out.

17. A method in accordance with claim 15 wherein the heating is carried out by at least one of radiation, electrical resistance heating and inductively.

18. A method in accordance with claim 13 wherein the structural elements are formed on the surface of the substrate by at least one of a dry chemical etching process, a dry physical etching process and a wet chemical etching process.

19. A method in accordance with claim 1 wherein the residual stress is influenced in a defined form with at least one layer applied to at least one of the front side and the rear side of the substrate.

20. A method in accordance with claim 19 wherein the residual stresses are compensated in the operating temperature range of the diffraction grating.

21. A method in accordance with claim 20 wherein the residual stress in the operating temperature range of the diffraction grating is set such that said diffraction grating is curved and the structured surface is one of planar, arched concavely and arched convexly.

22. A method in accordance with claim 1 wherein at least one of the rear side of the substrate and at least one of the layers applied to the rear side is structured for the defined influencing of residual stress.
